(19) United States
(12) Patent Application Publication
(10) Pub. No.: US 2003/0217435 A1
(43) Pub. Date: Nov. 27, 2003

(54) Clamp on adjustable male hinge

(76) Inventor: Edward Taglianetti, Marlboro, NJ (US)

Correspondence Address: EDWARD TAGLIANETTI, 181 RYAN ROAD, MARLBORO, NJ, 07746, US

(21) Appl. No.: 10/154,085

(22) Filed: May 24, 2002

(51) Int. Cl. E05D 7/04

(52) U.S. Cl. 16/246

(57) ABSTRACT

A two-part adjustable hinge is provided that is used in place of a standard gate hinge on a fence. The nut with attached pin can be adjusted upon the threads of the bolt attached to the clamp to change the distance between the post and the gate without installation of new materials.

### FIELD OF THE INVENTION

The present invention relates to fences used to surround land, and more specifically, to equipment used to connect a gate to a fence post.

### BACKGROUND OF THE INVENTION

Most fences surrounding land will have a gate to allow passage through the fence. During the construction of the fence, it is sometimes revealed that the standard hardware used to connect the gate to a fence post are not appropriately sized, resulting in the need to either remanufacture the gate or to move the post. This may be due to irregular calculations, defects or differences in the manufacture of the gate, or simply any other application that the standard hardware will not support. Rectifying these circumstances can be both costly and difficult; by the time the gate is attached to the post, the post has already been secured to the ground with concrete.

### SUMARY OF THE INVENTION

In light of the above, it is the object of the present invention to facilitate the connection of the gate to the fence post in these irregular circumstances.

The standard post clamp has been modified by the addition of a threaded bolt. The post clamp is attached to the post with a conventional bolt and nut.

A nut, modified by the addition of a smooth, round pin, is threaded upon the bolt and turned until the desired distance is achieved.

Then, the standard female bracket, attached to the gate, is mounted upon the round pin. The gate will swing on this pin.

As the nut with attached pin is adjustable upon the thread, the distance between the gate and the post can be varied without any difficulty.

### BRIEF DESCRIPTION OF THE DRAWINGS

FIG. 1. is a perspective view of the invention as it is intended to be installed, showing all parts, according to an embodiment of the present invetion.

FIG. 2. is a front view of the nut with attached round pin.

FIG. 3. is a side view of the nut with attached round pin.

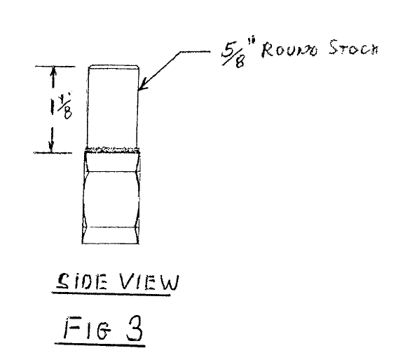

FIG. 4. is a front view of the clamp with attached threaded bolt.

FIG. 5. is a side view of the clamp with attached threaded bolt.

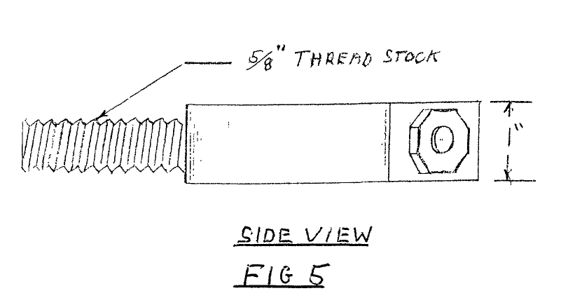

### DETAILED DESCRIPTION OF THE INVENTION

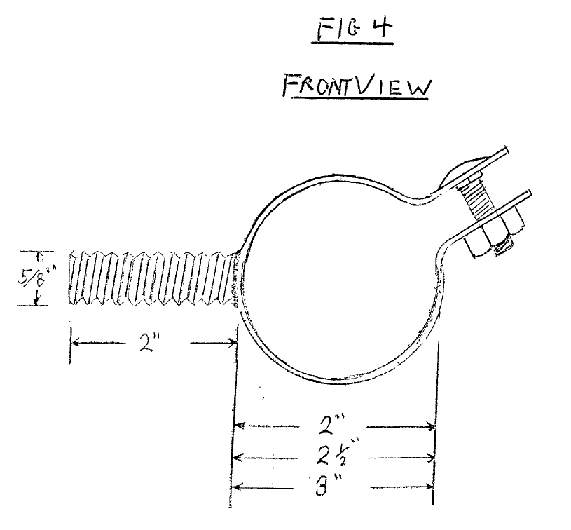

The standard post clamp shown in FIG. 4. has been modified by the addition of a threaded bolt. As indicated in the drawing, it is anticipated that clamps will be offered in several different sizes to accommodate different-sized posts. The post clamp is attached to the post with a conventional bolt and nut.

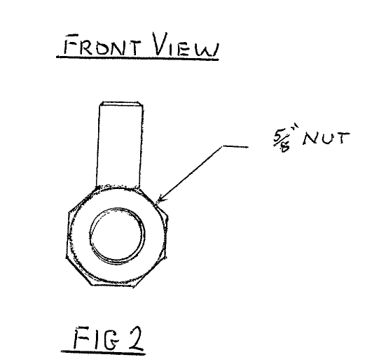

A nut, indicated in FIG. 2. has been modified by the addition of a smooth, round pin is threaded upon the bolt and turned until the desired distance is achieved.

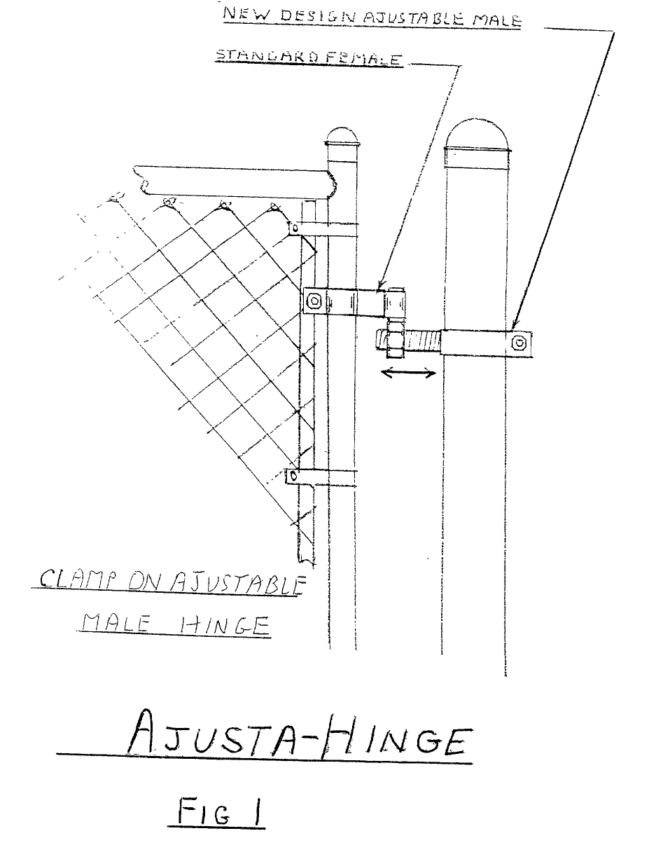

Then, the standard female bracket, attached to the gate and shown in FIG. 1. is mounted upon the round pin. The gate will swing on this pin.

As the nut with attached pin is adjustable upon the thread, the distance between the gate and the post can be varied without any difficulty.

It is anticipated that two or more such apparatuses will be used in connection with any one gate.

The foregoing is illustrative of the present invention and is not to be construed as limiting thereof Although a few exemplary embodiments of this invention have been described, those skilled in the art will readily appreciate that many modifications are possible without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the claims, with equivalents of the claims to be included therein.

That which is claimed is:

1. An apparatus for attaching a fence post to a fence gate, comprising:
a clamp with attached threaded bolt that is secured to an existing fence post using a conventional bolt and nut; and
a nut with attached round stock pin, wherein the nut is threaded upon the aforementioned clamp and a standard female gate bracket, attached to an existing gate, will slide and rest upon the round stock pin.
